(19) United States
(12) Patent Application Publication
(10) Pub. No.: US 2013/0138716 A1
(43) Pub. Date: May 30, 2013

(54) APPARATUS AND METHOD FOR PROVIDING ACTIVITY MONITORING AND ANALYSIS

(71) Applicants: Sanjay Macwan, Marlboro, NJ (US); Gokul Singaraju, Edison, NJ (US)

(72) Inventors: Sanjay Macwan, Marlboro, NJ (US); Gokul Singaraju, Edison, NJ (US)

(73) Assignee: AT&T Intellectual Property I, LP, Atlanta, GA (US)

(21) Appl. No.: 13/305,315

(22) Filed: Nov. 28, 2011

(51) Int. Cl. G08B 1/08; G06F 15/16

(52) U.S. Cl. 709/203; 340/539.11

(57) ABSTRACT

A system that incorporates teachings of the present disclosure may include, for example, detecting an occurrence of an activity by synthesizing sensory data collected at a mobile communication device according to one or more references corresponding to the activity, sharing tracking information associated with the detected occurrence of the activity over a communication network, and presenting feedback information corresponding to the tracking information. Other embodiments are disclosed.

### FIELD OF THE DISCLOSURE

The present disclosure relates generally to an apparatus and method for providing activity tracking and analysis in a telecommunication system.

### BACKGROUND

Mobile communication features remain central to the growth of the telecommunications industry. Many consumers demand features that balance telephony functionality, data accessibility, and enhanced life experiences. Useful enhancements allow consumers to capture experiential information in ways that provide insight into how they live. Consumers increasingly desire the ability to use these insights to memorialize past events and to improve future performance. Modern telecommunication devices and networks provide wide-ranging interconnectivity between consumer and system devices. As network capabilities expand, these interconnections provide new opportunities to enhance both telephonic communications and to integrate device capabilities into consumers' busy lives.

### BRIEF DESCRIPTION OF THE DRAWINGS

FIGS. 1-2 depict illustrative embodiments of communication systems that provide media services;

FIG. 3 depicts an illustrative embodiment of a web portal for interacting with the communication systems of FIGS. 1-2;

FIG. 4 depicts an illustrative embodiment of a communication device utilized in the communication systems of FIGS. 1-2;

FIG. 5 depicts an illustrative embodiment of a communication system;

FIG. 6 depicts an illustrative embodiment of a method that can be used in portions of the communication systems described in FIGS. 1-5; and

FIG. 7 is a diagrammatic representation of a machine in the form of a computer system within which a set of instructions, when executed, may cause the machine to perform any one or more of the methods discussed herein.

### DETAILED DESCRIPTION

The present disclosure describes, among other things, illustrative embodiments for providing activity monitoring and analysis by collecting sensory data at a mobile communication device, providing information associated with the activities to a server for logging and analysis, and supplying monitoring and analysis information to the mobile communication device. Other embodiments are contemplated by the present disclosure.

One embodiment of the present disclosure includes a mobile communication device having a memory coupled to a processor. The processor can be operable to collect a plurality of sensory data from one or more sensory devices at the mobile communication device. The processor can also be operable to access a list of a plurality of activities. Each activity of the plurality of activities can correspond to one or more trigger events of a plurality of trigger events that indicate a possible occurrence of the activity. Each activity can also include one or more references of a plurality of references for confirming an actual occurrence of the activity. The processor can further be operable to compare the collected plurality of sensory data to at least a portion of the plurality of trigger events that indicate the possible activity occurrence of a first activity of the plurality of activities. The processor can be operable to compare the collected plurality of sensory data to at least a portion of the plurality of trigger events to detect the one or more trigger events that indicate the possible occurrence of the first activity of the plurality of activities. The processor can, in turn, be operable to synthesize the collected plurality of sensory data according to at least a portion of the plurality of references to confirm the actual occurrence of the first activity in response to the indicated possible occurrence of the first activity. The processor can be operable to transmit tracking information associated with the confirmed actual occurrence of the first activity to a server over a communication network in response to the detecting of the possible occurrence of the first activity. The processor can also be operable to receive feedback information corresponding to the tracking information from the server. The processor can further be operable to present the feedback information at the mobile communication device.

One embodiment of the present disclosure includes a computer-readable storage medium including computer instructions, which, when executed by a processor, can cause the processor to collect sensory data at a mobile communication device. The sensory data can be collected from one or more sensors. The plurality of sensory data can be collected from one or more sensors. The computer instructions can also cause the processor to compare the collected sensory data to a plurality of trigger events to detect a possible occurrence of an activity in at least a vicinity of the mobile communication device. The computer instructions can further synthesize the collected sensory data according to a plurality of references to confirm an actual occurrence of the activity in response to the detecting of the possible occurrence of the activity. In turn, the computer instructions can store tracking information associated with the confirmed actual occurrence of the activity.

One embodiment of the present disclosure includes a method including detecting an occurrence of an activity by synthesizing sensory data collected at a mobile communication device according to one or more references corresponding to the activity. The method can also include sharing tracking information associated with the detected occurrence of the activity over a communication network. The method can further include presenting feedback information corresponding to the tracking information at the mobile communication device.

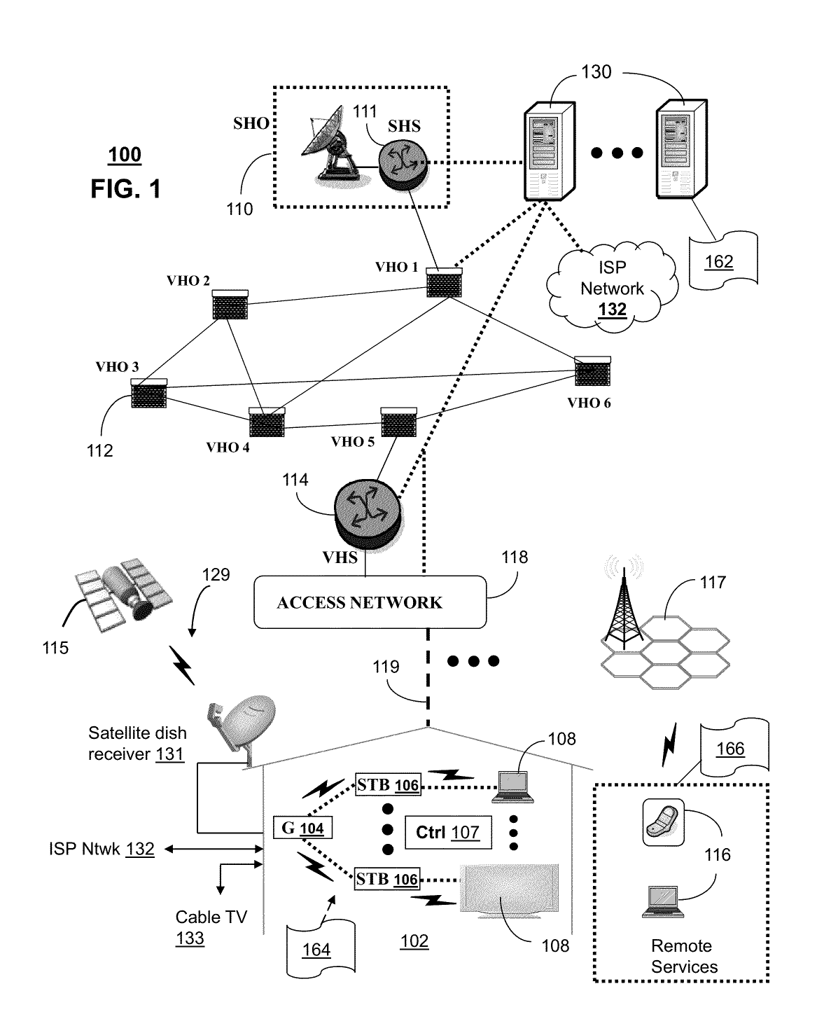

FIG. 1 depicts an illustrative embodiment of a first communication system 100 for delivering media content. The communication system 100 can represent an Internet Protocol Television (IPTV) media system. The communication system 100 can also provide for one or more of computing devices 130 to function as activity logging server device 130. An activity logging server device 130 can use common computing and communication technology to perform function 162, which includes among things, receiving and storing sensory data captured at a mobile communication device 116. The mobile communication device 116 can collect sensory data from sensory devices at the mobile communication device 116. The mobile communication device 116 can access a list of activities that can originate or be maintained at the activity logging server device 130. The activity logging server device 130 and the mobile communication device 116 can cooperate in tracking listed activities. The activity list can also include trigger events and references corresponding to the activities.

The mobile communication device 116 can compare the collected sensory data to the trigger events to detect possible occurrences of an activity. Once a possible occurrence is detected, the mobile communication device 116 can synthesize the collected sensory data according to the references to confirm an actual occurrence of the activity. If an actual occurrence of the activity is confirmed, then the mobile communication device 116 can transmit tracking information associated with the confirmed actual occurrence of the activity to the activity logging server device 130 over the communication network 100. The activity logging server device 130 can store the data, can analyze the data, and can provide feedback information to the mobile communication device 116.

The IPTV media system 100 can include a super head-end office (SHO) 110 with at least one super headend office server (SHS) 111 which receives media content from satellite and/or terrestrial communication systems. In the present context, media content can represent, for example, audio content, moving image content such as 2D or 3D videos, video games, virtual reality content, still image content, and combinations thereof. The SHS server 111 can forward packets associated with the media content to one or more video head-end servers (VHS) 114 via a network of video head-end offices (VHO) 112 according to a common multicast communication protocol.

The VHS 114 can distribute multimedia broadcast content via an access network 118 to commercial and/or residential buildings 102 housing a gateway 104 (such as a residential or commercial gateway). The access network 118 can represent a group of digital subscriber line access multiplexers (DSLAMs) located in a central office or a service area interface that provide broadband services over fiber optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered communication technologies (such as coaxial, powerline or phone line wiring) or can operate over a wireless access protocol such as Wireless Fidelity (WiFi), Bluetooth, Zigbee, or other present or next generation local or personal area wireless network technologies. By way of these interfaces, unicast communications can also be invoked between the media processors 106 and subsystems of the IPTV media system for services such as video-on-demand (VoD), browsing an electronic programming guide (EPG), or other infrastructure services.

A satellite broadcast television system 129 can be used also in the media system of FIG. 1. The satellite broadcast television system can be overlaid, operably coupled with, or replace the IPTV system as another representative embodiment of communication system 100. In this embodiment, signals transmitted by a satellite 115 carrying media content can be received by a satellite dish receiver 131 coupled to the building 102. Modulated signals received by the satellite dish receiver 131 can be transferred to the media processors 106 for demodulating, decoding, encoding, and/or distributing broadcast channels to the media devices 108. The media processors 106 can be equipped with a broadband port to the ISP network 132 to enable interactive services such as VoD and EPG as described above.

In yet another embodiment, an analog or digital cable broadcast distribution system such as cable TV system 133 can be overlaid, operably coupled with, or replace the IPTV system and/or the satellite TV system as another representative embodiment of communication system 100. In this embodiment, the cable TV system 133 can also provide Internet, telephony, and interactive media services. It is contemplated that the present disclosure can apply to any present or next generation over-the-air and/or landline media content services system.

Some of the network elements of the IPTV media system can be coupled to one or more computing devices 130, a portion of which can operate as a web server for providing web portal services over an Internet Service Provider (ISP) network 132 to wireline media devices 108 or mobile communication devices 116.

Multiple forms of media services can be offered to media devices over landline technologies such as those described above. Additionally, media services can be offered to media devices by way of a wireless access base station 117 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless network technologies are contemplated by the present disclosure.

FIG. 2 depicts an illustrative embodiment of a communication system 200 employing Internet Protocol Multimedia Subsystem (IMS) network architecture to facilitate the combined services of circuit-switched and packet-switched systems. Communication system 200 can be overlaid or operably coupled with communication system 100 as another representative embodiment of communication system 100. The communication system 200 can include or otherwise be coupled to the activity logging server device 130 of FIG. 1 for purposes similar to those described above. The communication system 200 can include or otherwise be coupled to the mobile communications device 116 of FIG. 1 for purposes similar to those described above. It is further contemplated by the present disclosure that the activity logging server device 130 and/or the mobile communication device 116 can perform the function 162 and thereby provide activity detecting, logging, and reporting for subscribers associated with CDs 201, 202, 203, and 205. CDs 201, 202, 203, and 205 can be adapted with software to perform function 170 to utilize and integrate with the activity detecting, logging, and reporting application performed by the mobile communication device 116 and/or activity logging server device 130. It is further contemplated that the activity logging server device 130 can be an integral part of the application servers) 217, where the application server(s) 217 performs function 172, which can be substantially similar to function 162 and adapted to the operation of the IMS network 250.

Communication system 200 can comprise a Home Subscriber Server (HSS) 240, a tElephone NUmber Mapping (ENUM) server 230, and other common network elements of an IMS network 250. The IMS network 250 can establish communications between IMS-compliant communication devices (CDs) 201, 202, Public Switched Telephone Network (PSTN) CDs 203, 205, and combinations thereof by way of a Media Gateway Control Function (MGCF) 220 coupled to a PSTN network 260. The MGCF 220 need not be used when a communication session involves IMS CD to IMS CD communications. A communication session involving at least one PSTN CD may utilize the MGCF 220.

IMS CDs 201, 202 can register with the IMS network 250 by contacting a Proxy Call Session Control Function (P-CSCF) which communicates with an interrogating CSCF (I-CSCF), which in turn, communicates with a Serving CSCF (S-CSCF) to register the CDs with the HSS 240. To initiate a communication session between CDs, an originating IMS CD 201 can submit a Session Initiation Protocol (SIP INVITE) message to an originating P-CSCF 204 which communicates with a corresponding originating S-CSCF 206. The originating S-CSCF 206 can submit the SIP INVITE message to one or more application servers (ASs) 217 that can provide a variety of services to IMS subscribers.

For example, the application servers 217 can be used to perform originating call feature treatment functions on the calling party number received by the originating S-CSCF 206 in the SIP INVITE message. Originating treatment functions can include determining whether the calling party number has international calling services, call ID blocking, calling name blocking, 7-digit dialing, and/or is requesting special telephony features (e.g., *72 forward calls, *73 cancel call forwarding, *67 for caller ID blocking, and so on). Based on initial filter criteria (iFCs) in a subscriber profile associated with a CD, one or more application servers may be invoked to provide various call originating feature services.

Additionally, the originating S-CSCF 206 can submit queries to the ENUM system 230 to translate an E.164 telephone number in the SIP INVITE message to a SIP Uniform Resource Identifier (URI) if the terminating communication device is IMS-compliant. The SIP URI can be used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE message to the terminating S-CSCF 214. The terminating S-CSCF 214 can then identify a terminating P-CSCF 216 associated with the terminating CD 202. The P-CSCF 216 may then signal the CD 202 to establish Voice over Internet Protocol (VoIP) communication services, thereby enabling the calling and called parties to engage in voice and/or data communications. Based on the iFCs in the subscriber profile, one or more application servers may be invoked to provide various call terminating feature services, such as call forwarding, do not disturb, music tones, simultaneous ringing, sequential ringing, etc.

In some instances the aforementioned communication process is symmetrical. Accordingly, the terms “originating” and “terminating” in FIG. 2 may be interchangeable. It is further noted that communication system 200 can be adapted to support video conferencing. In addition, communication system 200 can be adapted to provide the IMS CDs 201, 202 with the multimedia and Internet services of communication system 100 of FIG. 1. It is further contemplated that the CDs of FIG. 2 can operate as wireline or wireless devices. For example, the CDs of FIG. 2 can be communicatively coupled to a cellular base station 117 such as shown in FIG. 1, a femtocell (not shown), a WiFi router, a DECT base unit, or another suitable wireless access unit to establish communications with the IMS network 250 of FIG. 2.

If the terminating communication device is instead a PSTN CD such as CD 203 or CD 205 (in instances where the cellular phone only supports circuit-switched voice communications), the ENUM system 230 can respond with an unsuccessful address resolution which can cause the originating S-CSCF 206 to forward the call to the MGCF 220 via a Breakout Gateway Control Function (BGCF) 219. The MGCF 220 can then initiate the call to the terminating PSTN CD over the PSTN network 260 to enable the calling and called parties to engage in voice and/or data communications.

It is further appreciated that the CDs of FIG. 2 can operate as wireline or wireless devices. Although not shown, the CDs of FIG. 2 can be communicatively coupled to a cellular base station 221, a femtocell, a WiFi router, a DECT base unit, or another suitable wireless access unit to establish communications with the IMS network 250 of FIG. 2. The cellular access base station 121 can operate according to common wireless access protocols such as Global System for Mobile (GSM), Code Division Multiple Access (CDMA), Time Division Multiple Access (TDMA), Universal Mobile Telecommunications (UMTS), World interoperability for Microwave (WiMAX), Software Defined Radio (SDR), Long Term Evolution (LTE), and so on. Other present and next generation wireless network technologies are contemplated by the present disclosure. Accordingly, multiple wireline and wireless communication technologies are contemplated for the CDs of FIG. 2.

It is further contemplated that cellular phones supporting LTE can support packet-switched voice and packet-switched data communications and thus may operate as IMS-compliant mobile devices. In this embodiment, the cellular base station 221 may communicate directly with the IMS network 250 as shown by the arrow connecting the cellular base station 221 and the P-CSCF 216.

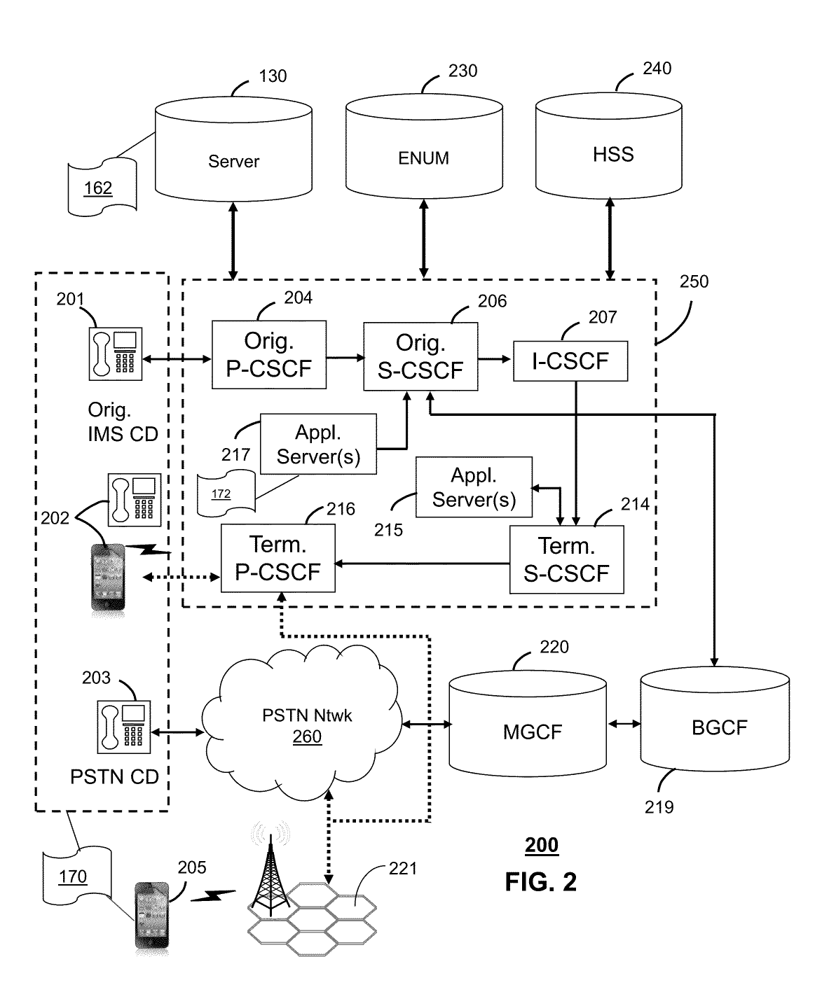

FIG. 3 depicts an illustrative embodiment of a web portal 302 which can be hosted by server applications operating from the computing devices 130 of the communication system 100 illustrated in FIG. 1. The web portal 302 can be used for managing services of communication systems 100-200. A web page of the web portal 302 can be accessed by a Uniform Resource Locator (URL) with an Internet browser such as Microsoft's Internet Explorer™, Mozilla's Firefox™, Apple's Safari™, or Google's Chrome™ using an Internet-capable communication device such as those described in FIGS. 1-2. The web portal 302 can be configured, for example, to access a media processor 106 and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor 106. The web portal 302 can also be used for provisioning IMS services described earlier, provisioning Internet services, provisioning cellular phone services, and so on.

It is contemplated by the present disclosure that the web portal 302 can further be utilized to manage and provision software applications 162-172 of the devices of FIGS. 1-2, respectively, as described earlier.

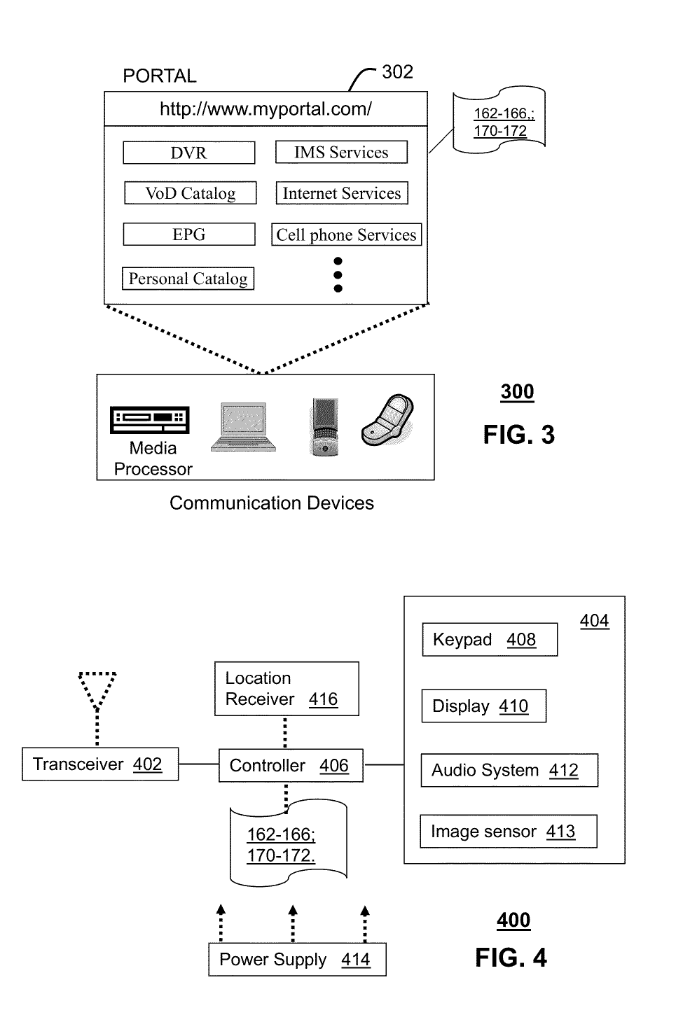

FIG. 4 depicts an exemplary embodiment of a communication device 400. Communication device 400 can serve in whole or in part as an illustrative embodiment of the devices depicted in FIGS. 1-2. The communication device 400 can comprise a wireline and/or wireless transceiver 402 (herein transceiver 402), a user interface (UI) 404, a power supply 414, a location receiver 416, and a controller 406 for managing operations thereof. The transceiver 402 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 402 can also be adapted to support circuit-switched wireline access technologies (such as PSTN), packet-switched wireline access technologies (such as TCPIP, VoIP, etc.), and combinations thereof.

The UI 404 can include a depressible or touch-sensitive keypad 408 with a navigation mechanism such as a roller ball, a joystick, a mouse, or a navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth. The keypad 408 can represent a numeric keypad commonly used by phones, and/or a QWERTY keypad with alphanumeric keys. The UI 404 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display 410 with navigation features.

The UI 404 can also include an audio system 412 that utilizes common audio technology for conveying low volume audio (such as audio heard only in the proximity of a human ear) and high volume audio (such as speakerphone for hands free operation). The audio system 412 can further include a microphone for receiving audible signals of an end user. The audio system 412 can also be used for voice recognition applications. The UI 404 can further include an image sensor 413 such as a charged coupled device (CCD) camera for capturing still or moving images.

The power supply 414 can utilize common power management technologies such as replaceable and rechargeable batteries, supply regulation technologies, and charging system technologies for supplying energy to the components of the communication device 400 to facilitate long-range or short-range portable applications. The location receiver 416 can utilize common location technology such as a global positioning system (GPS) receiver capable of assisted GPS for identifying a location of the communication device 400 based on signals generated by a constellation of GPS satellites, thereby facilitating common location services such as navigation.

The communication device 400 can use the transceiver 402 to also determine a proximity to a cellular, WiFi, Bluetooth, or other wireless access points by common sensing techniques such as utilizing a received signal strength indicator (RSSI) and/or a signal time of arrival (TOA) or time of flight (TOF). The controller 406 can utilize computing technologies such as a microprocessor, a digital signal processor (DSP), and/or a video processor with associated storage memory such as Flash, ROM, RAM, SRAM, DRAM or other storage technologies.

The communication device 400 can be adapted to perform the functions of the media processor 106, the media devices 108, or the mobile communication devices 116 of FIG. 1, as well as the IMS CDs 201-202 and PSTN CDs 203-205 of FIG. 2. It will be appreciated that the communication device 400 can also represent other common devices that can operate in communication systems 100-200 of FIGS. 1-2 such as a gaming console and a media player.

The communication device 400 can be adapted to perform the functions of the media processor 106, the media devices 108, or the mobile communication devices 116 of FIG. 1, as well as the IMS CDs 201-202 and PSTN CDs 203-205 of FIG. 2. It will be appreciated that the communication device 400 can also represent other common devices that can operate in communication systems 100-200 of FIGS. 1-2 such as a gaming console and a media player.

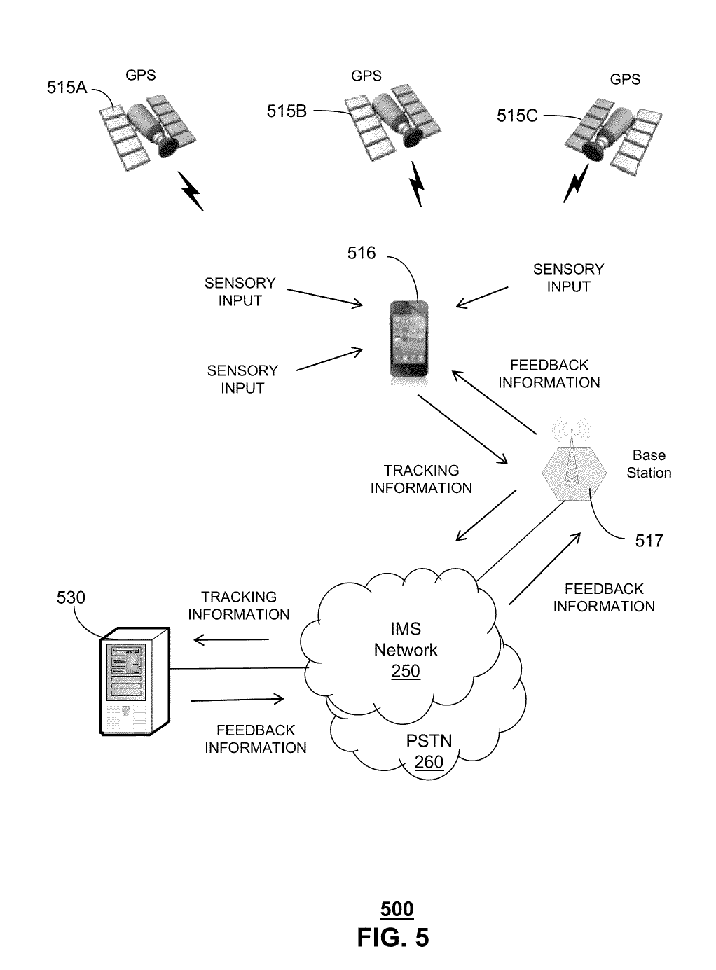

FIG. 5 depicts an illustrative embodiment of a communication system 500 for activity detecting, logging, and reporting. System 500 can be overlaid or operably coupled to communication systems 100-200 as another representative embodiment of communication systems 100-200. System 500 can include an activity logging server device 530 in communication with a packet switched network such as IMS network 250 and/or a circuit switched network such as a PSTN network 260 (see communication system 200 of FIG. 2). The activity logging server device 530 can be in communication with a mobile communication device 516 through the IMS network 250 or PSTN network 260. The mobile communication device 516 can be coupled to the IMS network 250 or PSTN network 260 via a base station 517. The mobile communication device 516 can receive various sensory inputs to capture information directly or indirectly associated with activities occurring in its proximity. The mobile communication device 516 can receive global position system (GPS) data from GPS satellites 515A, 515B, 515C, and can use this data to calculate location.

In one embodiment, the mobile communication device 516 can collect sensory data from sensory devices and from the GPS-based location data. The mobile communication device 516 can access a list of activities that can originate or be maintained at the activity logging server device 530. The activity logging server device 530 and the mobile communication device 516 can cooperate in tracking listed activities. The activity list can include trigger events and references corresponding to the activities. The mobile communication device 516 or the activity logging server 530 can compare the collected sensory data to the trigger events to detect possible occurrences of an activity. Once a possible occurrence is detected, the mobile communication device 516 or the activity logging server 530 can synthesize the collected sensory data according to the references to confirm an actual occurrence of the activity.

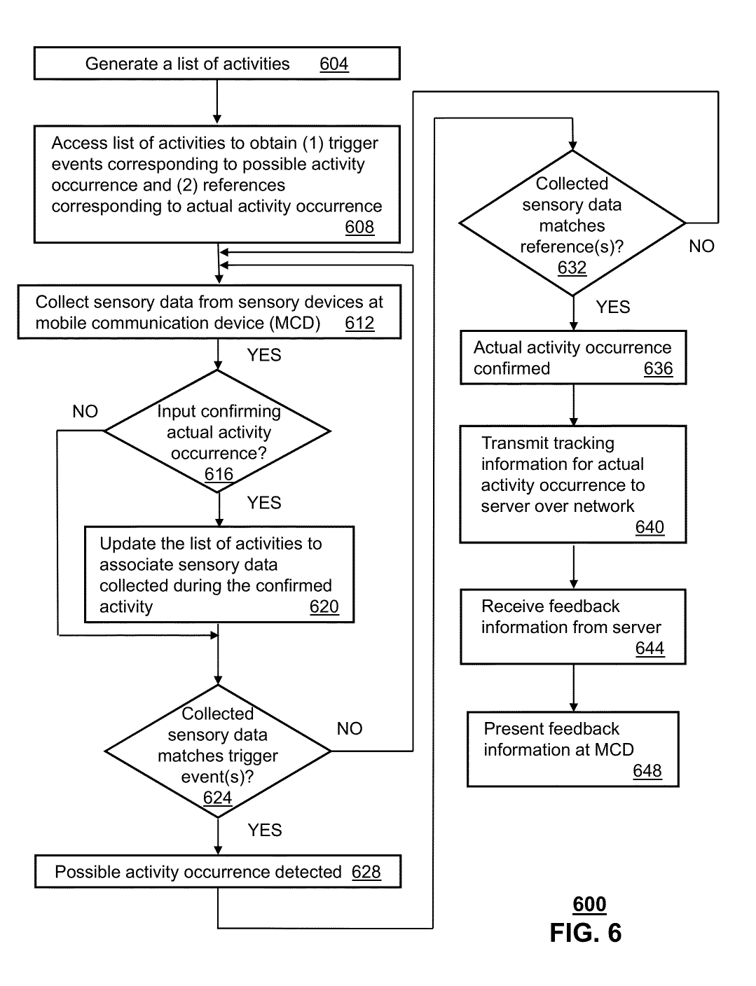

If an actual occurrence of the activity is confirmed, then the mobile communication device 516 can transmit tracking information associated with the confirmed actual occurrence of the activity to the activity logging server device 516 by way of the mobility network 517 and the IMS network 250. The activity logging server device 530 can store the data, analyze the data, and provide feedback information to the mobile communication device 516 (or another communication device of a user) by way of the IMS network 250, PSTN network 260, and/or the base station 517. The mobile communication device 516 and/or the activity logging server device 530 can thereby provide activity monitoring and analysis according to the illustrative embodiments of method 600 of FIG. 6.

FIG. 6 depicts an illustrative method 600 that operates in portions of the devices of FIGS. 1-5. Method 600 can begin with step 604 in which a list of activities can be generated. Activities can include events, actions, communications, or combination thereof, that can be detected and logged by the mobile communication device 516. Exemplary activities include, but are not limited to, physical fitness activities, such as walking, running, or bicycling, personal care activities, such as eating or sleeping, habits, such as smoking, business activities, such as making sales calls, or developmental activities, such as practicing a musical instrument, studying, or reading.

In one embodiment, the mobile communication device 516 can rely on data from sensory devices to determine an occurrence and nature of an activity. For example, the mobile communication device 516 can monitor a microphone input on the mobile communication device 516 and can determine that the user of the mobile communication device 516 is practicing piano by the sound captured by way of the microphone. In another example, the mobile communication device 516 can monitor a built-in accelerometer, gyroscope, and GPS detector to detect acceleration, orientation, and location information of the mobile communication device 516. The mobile communication device 516 can analyze the acceleration, orientation, and location data to determine that the user of the mobile communication device 516 is engaged in a self-propelled movement such as walking or running. In one embodiment, the mobile communication device 516 can monitor radiation. In another embodiment, the mobile communication device 516 can capture infrared video.

In one embodiment, the mobile communication device 516 can rely on user inputs to confirm an occurrence of an activity. The mobile communication device 516 can receive an input to a user interface element, such as a button press or a selection on a graphical user interface or speech command, where the received input indicates that the user is engaging in an activity of interest and wishes for the mobile communication device 516 to log this activity. For example, the user may wish for the mobile communication device 516 to log every time the user studies law from a hardcover book. The mobile communication device 516 can log these user-inputted occurrences.

In one embodiment, the mobile communication device 516 can combine user inputs with collected sensory data to determine when activities are occurring. The mobile communication device 516 can rely on a user input to detect the beginning of an activity or as a trigger that tells the mobile communication device 516 that the activity is imminent. The mobile communication device 516 can use the user input to determine when to collect sensory data associated with the event. For example, where a user wishes to log bicycle rides, the mobile communication device 516 can be alerted to an imminent ride by a user input to the mobile communication device 516. Once alerted, the mobile communication device 516 can then automatically log the time, distance, direction, and speed of the ride by way of the GPS, accelerometer, and gyroscope sensing capabilities of the mobile communication device 516.

In one embodiment, the list of activities can be maintained on the mobile communication device 516. The user can access the list on the mobile communication device 516 by a graphical user interface or by listing to an audio version of the list. The user can edit the contents of the list of activities by adding, deleting, or amending the list. Editing can be performed by way of a graphical user interface and input devices, such as a keypad, a mouse, a touch screen, a touch pad, a joystick, a pointing device, or speech input. Editing can be performed by way of vocal commands or manual entries. In one embodiment, the list of activities can be maintained on a remote device, such as the activity logging server device 530 or by way of a portal access 302 interface at a web site. The user can edit the contents of the list of activities by adding, deleting, or amending the list. Default activities can be suggested to the user. Where the activity list is maintained on a remote device, the remotely stored activity list can be transmitted to the mobile communication device 516 for use by the mobile communication device 516. The activity list can be incorporated into user profile data associated with the user of the mobile communication device 516.

In step 608, the mobile communication device 516 can access the list of activities to obtain trigger events that can be used to indicate possible occurrences of an activity or of multiple activities. The mobile communication device 516 can also access the list of activities to obtain references that can be used to confirm actual occurrences of an activity or of multiple activities. In one embodiment, each activity in the list of activities includes a corresponding list of trigger events and references for that activity. For example, an activity can be defined for “taking a walk with my friend, John.” One or more trigger events and one or more references can be defined for this activity. The mobile communication device 516 can, for example, monitor for a trigger event of “detecting the presence of John” to determine that the activity of “taking a walk with my friend, John” may be occurring. The mobile communication device 516 can wait until the trigger event (John's presence) is detected before attempting to detect if the user is walking with John. In this example, if the activity of “taking a walk with my friend, John” is enabled, then the mobile communication device 516 can collected sensory data directed at the trigger event for determining that John is present. The mobile communication device 516 can monitor microphone data or digital audio data to detect John's voice. Caller ID data can be monitored to detect when John has called. If the mobile communication device 516 detects John's presence by way of the trigger event, then the mobile communication device 516 can determine that the activity of “taking a walk with my friend, John” is possibly occurring.

Once the mobile communication device 516 determines that the activity is possibly occurring, then the mobile communication device 516 can begin to monitor collected sensory data for references that can be used to conclude that the activity is actually occurring. Returning to the example of the activity of “taking a walk with my friend, John,” the mobile communication device 516 can monitor an accelerometer input and a GPS input looking for accelerations and translational movements consistent with taking a walk. The listing may include a map of a walking path so that the collection of GPS data consistent with the walking path can be used by the mobile communication device 516 to confirm that the user is, indeed, taking a walk with his/her friend, John.

Activities in the list can include multiple trigger events and multiple references. Trigger events and references can be applied to multiple activities. For example, the activities of jogging and walking can both include a trigger event of GPS data indicating a location where the user always begins these activities. Trigger events and references can be defined as requiring combined detection or alternative detections. An activity may be defined to require that the mobile communication device 516 detected both trigger event A and trigger event B before determining that an activity is possibly occurring. Alternatively, the mobile communication device 516 may only require either event A or event B before determining a possible activity occurrence. Similarly, references such a location with a corresponding path, voice signature of an individual, time of day, specific calendar date, or other suitable combination of references may be defined in the activity list to confirm an activity occurrence. In one embodiment, activities can be defined with no trigger event. In such a case, the mobile communication device 516 can monitor the collected sensory data for a reference or references at all times and confirm an activity as soon as the reference requirement is met.

In step 612, sensory data can be collected from sensory devices at the mobile communication device 516. The sensory data can be any information that the mobile communication device 516 can access directly or indirectly. Exemplary sensory data includes, but is not limited to, audio sensors (e.g., microphones), accelerometers, gyroscopes for detecting orientation, panning video sensors, GPS receiving and decoding functions, light sensors, video sensors, temperature sensors, moisture sensors, air quality sensors, odor sensors, radio frequency sensors (e.g., WiFi or BlueTooth receiving antennas and circuits), cellular network location and vicinity indicators (e.g., location of base unit currently accessed, list of contacts currently accessing the same base unit), biometric sensors (e.g., heartbeat, blood pressure, body temperature, body moisture, blood glucose).

The sensory data can include data from sensors built into the mobile communication device 516 or sensory data that is captured by an input port of the mobile communication device 516. For example, the mobile communication device 516 can capture sensory data from remote sensors communicatively coupled to the mobile communication device 516. Remote sensors can be located at other mobile communication devices in a communication range of the mobile communication device 516 that are enabled to share sensory data with the mobile communication device 516. Remote sensors can also include stationary sensors in a vicinity of the mobile communication device 516 such as webcams, weather sensors, and so on, which may be available for public use. In one embodiment, the sensory data can be classified into one or several categories, which may be relevant to the user, and store this categorized sensory data according to other categorical sensory data such as location and time.

The sensory data can be captured, directly, by a another device, including another mobile communication device 516, and then relayed to the mobile communication device 516 by way of text messaging, cellular digital data, or 3G/LTE communications. The sensory data can be collected by the mobile communication device 516 by monitoring the digital voice data for calls initiated at or received by the mobile communication device 516. The sensory data can be extracted from text messages or email messages or social media content accessed by the mobile communication device 516. The mobile communication device 516 can receive sensory data from multiple sensory devices at the same time. Sensory devices can be coupled directly to the mobile communication device 516 by wired or wireless connections or the sensory data from sensory devices can be collected by another device and then be reported to the mobile communication device 516 over a communication link.

The mobile communication device 516 can control when sensory data is collected. In one embodiment, the mobile communication device 516 can reference a user profile to determine when to collect sensory data for use in activity detection and tracking. For example, the user profile can require a user input of a password or a biometric feature to activate the sensory data collection. This feature can be particularly useful where the mobile communication device 516 might be shared with another user or where the user is concerned about when and where sensory data is collected. In another example, the user profile can require a user to select a special function key to enable sensory data collection. In one embodiment, the user profile could require the user to select one or more activities to track before the collection of sensory data begins. In one embodiment, the user profile can require a password or biometric input to enable the collection of certain sensory data while allowing other sensory data to be collected by default. In one embodiment, the mobile communication device 516 can default to collect sensory data whenever the device is turned on.

In step 616, the mobile communication device 516 can monitor for an input to a user interface that can be used to confirm that an occurrence of an activity of interest that is in the activity list. The mobile communication device 516 can receive an input from a user that confirms the occurrence of an activity that the user wishes to track with the mobile communication device 516. For example, the user may wish to track every time he eats pasta, but the mobile communication device 516 may have no means to detect this activity, directly or indirectly, using sensory devices available to the mobile communication device 516. In this case, the activity of “eating pasta” is defined in the activity list to require a user input to confirm. An exemplary user input can be a voice command to the mobile communication device 516, such as, “eating pasta.” The mobile communication device 516 can detect this input and log the activity. When still or video imagery can be captured by an image sensor of the mobile communication device 516 or a remote image sensor (e.g., webcam) which can supply sensory data to the mobile communication device 516, image processing technology can be used to detect that the user is eating pasta, thereby detect the occurrence of an activity of interest in the activity list, and begin collecting sensory data from this point forward. In this embodiment, user input can be avoided.

In one embodiment, the mobile communication device 516 can receive a user input to confirm the occurrence of an activity as part of a training sequence to improve an ability of the mobile communication device 516 to confirm an occurrence of an activity using sensory data. For example, the user activity of “running” can be defined to require a reference of a certain acceleration motion as detected by an accelerometer input. When the mobile communication device 516 first attempts to confirm the activity of running, however, the device does not know the level of accelerometer data that corresponds to the user running with the mobile communication device 516 in his/her pocket. To train the mobile communication device 516, the user can confirm, by an input to the mobile communication device 516, that he/she is actually running The mobile communication device 516 can monitor the accelerometer input during this time of confirmed running activity to collect accelerometer data consistent with running to profile the user's running style.

After the mobile communication device 516 has been trained, the mobile communication device 516 can confirm the activity of running, based on the accelerometer data, without requiring a separate input by the user. Once an occurrence of an actual activity is confirmed either detection of an input confirming the activity, in step 616, then the mobile communication device 516 can update the list of activities to associate the sensory data collected during the confirmed occurrence of the actual activity in step 620.

In one embodiment, user input can also be used to identify an occurrence of speech communication with a party of interest (e.g., “friend John”). For example, when the user defined the activity of “taking a walk with my friend, John,” the user may not have been able to supply a voice sample of John. By way of user input, the mobile communication device 516 can be informed by the user that John is present, and that a conversation is taking place. Using speech recognition technology, the mobile communication device 516 can distinguish between a known profile of the user's voice and a new voice, that of John. The mobile communication device 516 can store samples of John's voice, or profile John's voice as a trigger for detecting the possible occurrence of the activity. Such a trigger can also be supplied to the activity logging server 530.

In another embodiment, at the time the user defines the activity “taking a walk with my friend, John,” the user may have provided a caller ID of John's mobile phone. In this embodiment, the mobile communication device 516 of the user can automatically engage in sampling John's voice using voice recognition techniques that distinguish the user's voice from John's voice when John calls the mobile communication device 516 with his mobile phone. In this embodiment, user input can be avoided.

Based on the foregoing embodiments, the subject disclosure contemplates that the mobile communication device 516 and/or the activity logging server 530 can implement software algorithms which would enable them to add new triggering data as well as reference information to one or more activities in the activity list when additional sensory information is detected and such information can be used to enhance triggers and/or references of any activity of interest in the activity list. Such an algorithm can continuously enhance possible detection and confirmation of activities in the activity list.

In step 624, the mobile communication device 516 can compare the collected sensory data to the trigger events. Where the user has not made an input to the mobile communication device 516 to positively confirm the occurrence of an activity, then the mobile communication device 516 (or the activity logging server 530 based on sensory data supplied by the mobile communication device 516) can monitor the collected sensory data to determine if the data corresponds to any of the trigger events defined in the list of activities. The mobile communication device 516 (or the activity logging server 530 based on sensory data supplied by the mobile communication device 516) can monitor for trigger events as a default background task. If the collected sensory data does not indicate a trigger event, then the mobile communication device 516 will continue collecting sensory data, in step 612, and checking to see if the sensory data corresponds to one of the trigger events, in step 624. If the collected sensory data matches a trigger event or matches more than one trigger event, in step 624, then the mobile communication device 516 (or the activity logging server 520) can indicate a possible occurrence of an activity or of more than one activity in step 628.

In step 632, the mobile communication device 516 can compare the collected sensory data to references identified for activities in the activity list to confirm the occurrence of the suspected activity detected in steps 624 and 628. Where the user has not made an input to the mobile communication device 516 to positively confirm the occurrence of an activity, then the mobile communication device 516 can monitor the collected sensory data to determine if the data corresponds to any of the references defined in the list of activities. Once the mobile communication device 516 detects a trigger event for an activity, the mobile communication device 516 can monitor for a reference to confirm the activity. If the collected sensory data does not indicate a trigger event, then the mobile communication device 516 will continue collecting and comparing the sensory data to see if the sensory data corresponds to one of the references, in step 632. If the collected sensory data matches a reference or matches more than one reference, in step 632, then the mobile communication device 516 can confirm the occurrence of the activity or of more than one activity in step 636.

For example, the mobile communication device 516 (or the activity logging server 530) can detect the presence of John. Suppose that the user has defined an activity to record a conversation with John when they walk together in a specific park. Further suppose, that the sensory data indicate that the user is walking in the park referenced in the activity, and John's voice is still present. From this additional sensory information, the mobile communication device 516 (or the activity logging server 530) can confirm that in fact the activity has taken place, and begin at step 649 to collect sensory data about the activity (e.g., information about walk, path taken, audio recording of conversation, etc.).

In step 640, the mobile communication device 516 can transmit tracking information for the actual activity to the activity logging server device 530. In one embodiment, the tracking information can include a “bare record” that only includes the activity or a code associated with the activity and a time and date stamp. In one embodiment, the tracking information may include the relevant sensory data collected during the occurrence. For example, during a confirmed activity of “running,” the mobile communication device 516 can log raw accelerometer and GPS data, as well as data for speed and distance that the mobile communication device 516 has calculated from the GPS data. The mobile communication device 516 can also send biometric information such as heart rate, perspiration rate, body temperature, and so on to enable the activity logging server 530 to assess health characteristics of the user. The mobile communication device 516 can send the biometric information a well as the calculated speed and distance data to the activity logging server device 530. In another embodiment, the mobile communication device 516 can send all of the raw sensory data collected during an activity to allow the activity logging server device 130 to perform analysis on the raw data and synthesize relevant information therefrom. In one embodiment, the mobile communication device 516 can be configured, generally, to transmit the tracking data to the activity logging server device 530 according to the above-described modes. In one embodiment, the tracking data mode is configured on an activity-by-activity basis according to the activity list.

In one embodiment, the mobile communication device 516 can transmit tracking information by way of a short messaging service (SMS) channel or a data channel. The tracking information can be transmitted using SMS short codes. In one embodiment, the mobile communication device 516 can aggregate the collected sensory data into a compressed format before the tracking information is transmitted to the activity logging server device 530. The activity logging server device 530 can read and decode compressed tracking information upon receipt so that uncompressed data is available at the activity logging server device 530.

In step 644, the mobile communication device 516 (or another communication device of the user) can receive feedback information from the activity logging server device 530. The feedback information can be in the form of a summary of the tracking information reported to the activity logging server device 530 over a period of time. The feedback information can be one or more statistical measurements from the tracking information. For example, the feedback information may return mean, standard deviation, median, cumulative, and range measurements from the tracking data. The feedback information can be in the form of a voice message to the mobile communication device 516 acknowledging the activity or instructing the user in some facet of the activity (e.g., slow down, your heart rate is too fast).

In one embodiment, the user can input goals associated with the activity at the activity logging server device 530. For example, the user may have time or distance goal associated with an activity of “running” The activity logging server device 530 can provide feedback information to the mobile communication device 516 comparing the performance of the activity to the goal. In one embodiment, the activity logging server device 530 can share the tracking information or the feedback information with other devices over the communication network 100. In one embodiment, the activity logging server device 530 can share the tracking information or the feedback information with third parties for the purpose of advertising or promotions. The activity logging server device 530 can use artificial intelligence to classify and analyze the records and synthesize conclusions which can be shared with the user of the mobile communication device 516.

In one embodiment, a user can access the feedback information from a mobile communication device 516 or from the portal 302. The activity logging server device 530 can limit access to the feedback information according to the provision of authentication information, such as a unique device or system identifier, a password, a biometric input, or an encrypted certification. In one embodiment, the activity logging server device 530 can process user queries of the feedback information and interact with the user. Queries to the activity logging server device 530 can be accomplished by voice commands, text commands, or by pre-configured commands in a graphical user interface at the mobile communication device 516 or the portal 302. The feedback information can be reported to the user as voice, text, graphics, or video.

In step 648, the mobile communication device 516 can present the feedback information. The feedback information can be displayed on a graphical user interface of the mobile communication device 516. The feedback information can be a voice message or a text message to the mobile communication device 516. In one embodiment, the feedback can be in the form of an avatar, or humanoid persona. In one embodiment, the user can choose an avatar with preferred characteristics including language, language dialect, age, sex, and social interests. The user of the mobile communication device 516 can configure an avatar at the activity logging server device 530. When the activity logging server device 530 reports feedback information to the mobile communication device 516, the avatar can be displayed on the mobile communication device 516

In one embodiment, a mobile communication device 516 can be used to track a user's physical fitness activity such as daily running The mobile communication device 516 can record the time duration of the activity and performance parameters such as speed and distance. The reporting of this data to the activity logging server device 530 allows the user to view, by way of the feedback information, progress toward fitness goals as well as seeing where the fitness activity may or may not have happened due to the busy schedule of the user. In one embodiment, a mobile communication device 516 can be used to track if a child has kept up with goals established for a reading activity or any other practice activity, such as music lessons or exercise. A first mobile communication device 516, belonging to a child, can monitor sensory data to detect the target activity. A second mobile communication device 516, belonging to a parent, can upload feedback information on the child's activities from an activity logging server device 530.

Upon reviewing the aforementioned embodiments, it would be evident to an artisan with ordinary skill in the art that said embodiments can be modified, reduced, or enhanced without departing from the scope and spirit of the claims described below. For example, in one embodiment, the collected sensory data can be transmitted to the activity logging server device 530 periodically. The activity logging server device 530 can perform the tasks of detecting trigger events and references to detect activity occurrences.

In one embodiment, the feedback information from the activity logging server device 530 can be reported to another device of the user of the mobile communication device 516. In one embodiment, where the activity logging server device 530 shares the tracking or feedback information with a third party, the user of the mobile communication device 516 can be given an opportunity to opt-in or to opt-out of the features. The opt-out and opt-in features can be activated under the terms of a rewards or incentives plan. In one embodiment, the system can be used to track usage of a product or service that requires replacement. For example, for an activity such as running or walking, the number of miles of usage of a pair of shoes could be tracked and reported to third parties in the feedback information. This usage information could be used by third parties to trigger sending advertising or special discount information to the user as part of the feedback information. Similar features could incorporate other types of replaceable goods and services, such as automotive maintenance items or product service plans. In one embodiment, a user profile can include user attribute information, such as the user's age, sex, residing area, social interests, or shopping preferences. A promotional or advertising system can access this user information, along with the feedback information, to tailor advertising or special offers to the user as part of the feedback information.

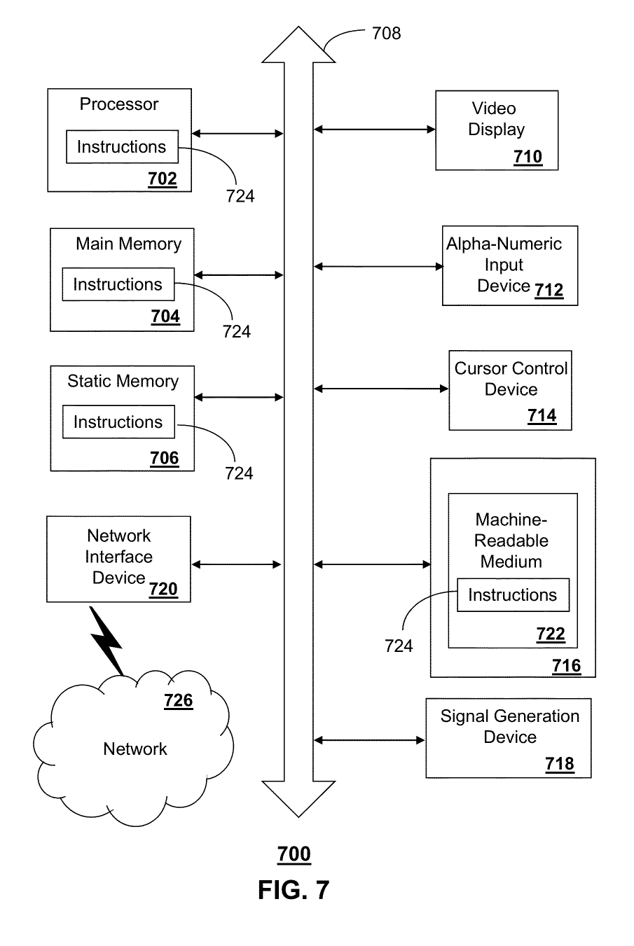

FIG. 7 depicts an exemplary diagrammatic representation of a machine in the form of a computer system 700 within which a set of instructions, when executed, may cause the machine to perform any one or more of the methods discussed above. One or more instances of the machine can operate, for example, as the activity logging server device 130, the media processor 506A-C, the gateway 504A-B, the mobile communication device 516A-H, or combinations thereof as described above. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal displays (LCD), a flat panel, or a solid state display. The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a tangible computer-readable storage medium 722 on which is stored one or more sets of instructions (e.g., software 724) embodying any one or more of the methods or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute tangible computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the tangible computer-readable storage medium 722 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the present disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA) are contemplated for use by computer system 800.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A mobile communication device, comprising a memory coupled to a processor, wherein the memory comprises computer instructions, which when executed by the processor, cause the processor to:
collect a plurality of sensory data from one or more sensory devices communicatively coupled to the mobile communication device;
access a list of a plurality of activities, wherein each activity of the plurality of activities comprises one or more trigger events of a plurality of trigger events that indicate a possible occurrence of the activity and wherein each activity comprises one or more references of a plurality of references for confirming an actual occurrence of the activity;
compare the collected plurality of sensory data to at least a portion of the plurality of trigger events to detect the one or more trigger events that indicate the possible occurrence of a first activity of the plurality of activities;
responsive to the detecting of the possible occurrence of the first activity, synthesize the collected plurality of sensory data according to one or more of the plurality of references to confirm the actual occurrence of the first activity;
responsive to the confirmed actual occurrence of the first activity, transmit tracking information associated with the confirmed actual occurrence of the first activity to a server over a communication network;
receive feedback information corresponding to the tracking information from the server; and
present the feedback information at the mobile communication device.

2. The mobile communication device of claim 1, wherein the one or more sensor devices comprise at least one of a microphone, a video sensor, a panning video sensor, an accelerometer, a gyroscope, a biometric sensor, a global positioning satellite receiver, a light sensor, a wireless signal detector, an air quality sensor, temperature sensor, a barometer sensor, a moisture sensor, a radiation sensor, an infrared video sensor, or a single one of the foregoing sensors, or combinations thereof.

3. The mobile communication device of claim 1, wherein the activities comprise one or more events, actions, or communications that detectable at the mobile communications device.

4. The mobile communication device of claim 1, wherein the tracking information comprises at least one or more codes associated with the actual occurrence of the first activity, one or more timestamps associated with the actual occurrence of the first activity, or at least a portion of the collected plurality of sensory data associated with the actual occurrence of the first activity.

5. The mobile communication device of claim 1, wherein the feedback information comprises at least one of a summary of the tracking information, statistical measurements of the tracking information, or a voice message associated with the tracking data, or a comparison of the tracking information to a goal.

6. The mobile communication device of claim 1, wherein the processor is operable to:
receive an input from a user interface confirming the occurrence of the first activity;
responsive to receiving the input, update the list of the plurality of activities to associate at least a portion of the collected plurality of sensory data with the first activity.

7. The mobile communication device of claim 1, wherein the processor is operable to:
determine a new reference to confirm the actual occurrence of the first activity; and
update the list of the plurality of activities to add the determined new reference to the one or more references of the plurality of references that confirm an actual occurrence of the first activity.

8. The mobile communication device of claim 1, wherein the processor is operable to:
connect to a website over the communication network;
receive the feedback information from the server; and
present the received feedback information by way of a user interface of the website.

9. The mobile communication device of claim 1, wherein the processor is operable to transmit authenticating information to the server to enable the mobile communication device to receive the feedback information.

10. The mobile communication device of claim 1, wherein the processor is operable to:
receive information corresponding to an avatar for presentation at the mobile communication device; and
present the feedback information at the mobile communication device by way of the avatar.

11. The mobile communication device of claim 1, wherein the feedback information comprises at least one of a reminder to perform one or more of the plurality of activities, a summary of the tracking information, or a comparison of the tracking information for the first activity to one or more goals.

12. A computer-readable storage medium comprising computer instructions, which when executed by a processor causes the processor to:
collect sensory data at a mobile communication device, wherein the sensory data is collected from one or more sensors;
compare the collected sensory data to a plurality of trigger events to detect one or more trigger events to detect a possible occurrence of an activity in at least a vicinity of the mobile communication device;
responsive to the detecting the possible occurrence of the activity, synthesize the collected sensory data according to a plurality of references to confirm an actual occurrence of the activity; and
store tracking information associated with the confirmed actual occurrence of the activity.

13. The storage medium of claim 12, wherein the computer instructions cause the processor to:
transmit the tracking information to a server over a communication network;
receive at a user interface at the mobile communication device a command requesting feedback information from the server; and
transmit a request to the server for the feedback information.

14. The storage medium of claim 13, wherein the computer instructions cause the processor to:
transmit authenticating information to the server;
receive at the mobile communication device the feedback information responsive to the server validating the authenticating information.

15. The storage medium of claim 12, wherein the tracking information comprises at least one or more of codes associated with the actual occurrence of the first activity, one or more timestamps associated with the actual occurrence of the first activity, or at least a portion of the collected sensory data associated with the actual occurrence of the first activity.

16. The storage medium of claim 12, wherein the feedback information comprises at least one of a summary of the tracking information, or statistical measurements of the tracking information, or a voice message associated with the tracking data, or a comparison of the tracking information to a goal.

17. The storage medium of claim 12, wherein the one or more sensors comprise at least one of a microphone, a video sensor, a panning video sensor, an accelerometer, a gyroscope, a biometric sensor, a global positioning satellite receiver, a light sensor, a wireless signal detector, an air quality sensor, temperature sensor, a barometer sensor, a moisture sensor, a radiation sensor, an infrared video sensor, or a single one of the foregoing sensors, or combinations thereof.

18. A method, comprising:
detecting an occurrence of an activity by synthesizing sensory data collected at a mobile communication device according to one or more references corresponding to the activity;
sharing tracking information associated with the detected occurrence of the activity over a communication network; and
presenting feedback information corresponding to the tracking information at the mobile communication device.

19. The method of claim 18, comprising:
receiving an input at a user interface of the mobile communication device confirming the detected occurrence of the activity; and
responsive to the confirming the detected occurrence of the activity, updating the one or more references according to the collected sensory data to confirm the activity in a future occurrence without receiving the input at the user interface.

20. The method of claim 18, comprising:
receiving information corresponding to an avatar for presentation at the mobile communication device; and
presenting the feedback information at the mobile communication device by way of the avatar.
